(19) United States
(12) Patent Application Publication
(10) Pub. No.: US 2015/0061421 A1
(43) Pub. Date: Mar. 5, 2015

(54) ELECTRIC COMPRESSOR

(71) Applicant: KABUSHIKI KAISHA TOYOTA JIDOSHOKKI, Kariya-shi (JP)

(72) Inventors: Junya YANO, Kariya-shi (JP); Takuro MIZUNO, Kariya-shi (JP); Ken SUITOU, Kariya-shi (JP); Junichi TAKAHATA, Kariya-shi (JP); Fumihiro KAGAWA, Kariya-shi (JP); Shingo ENAMI, Kariya-shi (JP)

(73) Assignee: KABUSHIKI KAISHA TOYOTA JIDOSHOKKI, Kariya-shi (JP)

(21) Appl. No.: 14/475,022

(22) Filed: Sep. 2, 2014

(30) Foreign Application Priority Data
Sep. 3, 2013 (JP) 2013-182045

(51) Int. Cl. H02K 9/00; H02K 11/00

(52) U.S. Cl. CPC H02K 9/00; H02K 11/0068
USPC 310/52

(57) ABSTRACT

An electric compressor includes: a compressing unit; an electric motor that rotates the compressing unit; and a driving circuit. The driving circuit includes a filter circuit, an inverter circuit that receives electric power from the power supply line via the filter circuit, and a circuit board on which the inverter circuit is disposed, and a base member (aluminum base) and that supports the circuit board. The filter circuit has an electromagnetic coil and a damping resistor. The damping resistor is fixed to the aluminum base in abutment with the aluminum base. Preferably, the filter circuit is mounted on the circuit board, and the damping resistor has a lead line soldered to the circuit board and is fixed to the aluminum base by a screw. With this, there can be provided the electric compressor capable of effectively cooling the damping resistor of the filter circuit.

This nonprovisional application is based on Japanese Patent Application No. 2013-182045 filed on Sep. 3, 2013, with the Japan Patent Office, the entire contents of which are hereby incorporated by reference.

### BACKGROUND OF THE INVENTION

1. Field of the Invention

The present invention relates to an electric compressor, in particular, an electric compressor provided with a filter circuit in a power supply input portion.

2. Description of the Background Art

As electric compressors for vehicles, there has been developed an electric compressor in which a driving circuit for driving a motor is incorporated for size reduction. If switching noise of the driving circuit of the electric compressor is leaked to outside, an adverse effect may be provided on a radio of the vehicle or the like. To address such a case, a filter circuit is generally provided in a power supply input portion thereof.

Japanese Patent Laying-Open No. 2010-48103 has discussed to dispose a low-pass filter circuit between a battery and an inverter circuit in order to suppress high-frequency noise in an output voltage of the battery from being generated due to an operation of the inverter circuit.

### SUMMARY OF THE INVENTION

For such a low-pass filter circuit, an LC filter is usually used. However, the use of the LC filter results in resonance by L (reactance) of a coil and C (capacitance) of a capacitor at a specific frequency.

In order to avoid such resonance, an element constant is changed or the switching frequency of the inverter circuit is changed when the switching frequency of the inverter circuit is around the resonance frequency.

In the case where the element constant is changed, a damping resistor is provided in the filter circuit to let a DC component flow in the coil and let an AC component flow in the resistor, thereby lowering the resonance level.

The damping resistor thus added to the filter circuit receives a ripple current flowing from the system power supply side not only when starting an operation of the compressor but also when stopping the operation of the compressor. This may result in heat generation.

In such a case, in order to avoid the temperature of the damping resistor from being increased to reach or exceed the heat resistant temperature, the damping resistor needs to be effectively cooled also when stopping the operation of the compressor.

The present invention has an object to provide an electric compressor capable of effectively cooling a damping resistor of a filter circuit.

To summarize, the present invention provides an electric compressor including: a compressing unit; an electric motor that rotates the compressing unit; and a driving circuit that drives the electric motor. The driving circuit includes a filter circuit inserted in a power supply line, an inverter circuit that receives electric power from the power supply line via the filter circuit, and a circuit board on which the inverter circuit is disposed. The filter circuit includes a coil, and a damping resistor. The damping resistor is cooled by suctioned refrigerant suctioned in the electric compressor.

According to the present invention, the damping resistor is effectively cooled to improve reliability of the electric compressor.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an entire configuration of an electric compressor of the present embodiment.

FIG. 2 is a circuit diagram of a driving circuit that drives an electric compressor motor.

FIG. 3 is a perspective view showing an external appearance of an inverter unit.

FIG. 4 shows a lamination structure within the inverter unit.

FIG. 5 is a perspective view showing the shape of an aluminum base.

FIG. 6 is a cross sectional view of a VI-VI portion in FIG. 5.

FIG. 7 illustrates a first modification.

FIG. 8 illustrates a second modification.

### DESCRIPTION OF THE PREFERRED EMBODIMENTS

The following describes an embodiment of the present invention in detail with reference to figures. It should be noted that the same or corresponding portions in figures are given the same reference characters and are not described repeatedly.

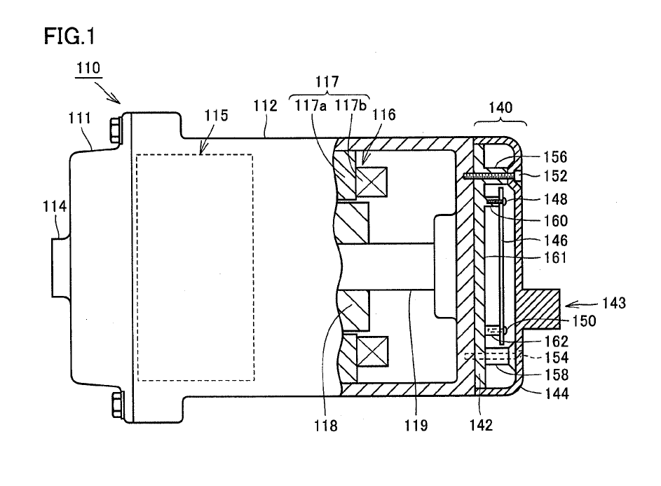

FIG. 1 shows an entire configuration of an electric compressor of the present embodiment. Referring to FIG. 1, the electric compressor 110 includes: a housing formed by joining an discharge housing 111, which has a cover-like shape and is made of aluminum (metal material), to a suction housing 112, which has a shape of cylinder with a bottom and is made of aluminum (metal material); a compressing unit 115 and an electric motor 116, which are accommodated in the suction housing 112; and an inverter unit 140 attached to the suction housing 112 such that the inverter unit 140 is incorporated with the suction housing 112.

A suction port not shown in the figure is formed at the bottom portion side of the circumferential wall of the suction housing 112. Connected to the suction port is an external refrigerant circuit not shown in the figure. A discharge port 114 is formed at the cover side of the discharge housing 111. The discharge port 114 is connected to the external refrigerant circuit. Accommodated in the suction housing 112 are: the compressing unit 115 for compressing refrigerant; and the electric motor 116 for driving the compressing unit 115. Although not shown in the figure, for example, the compressing unit 115 is configured to include a fixed scroll fixed in the suction housing 112 and a movable scroll disposed to face the fixed scroll.

On the inner circumferential surface of the suction housing 112, a stator 117 is fixed. The stator 117 is configured to include: a stator core 117a fixed to the inner circumferential surface of the suction housing 112; and coils 117b wound around teeth (not shown) of the stator core 117a.

In the suction housing 112, a rotating shaft 119, which is inserted in the stator 117, is rotatably supported. To this rotating shaft 119, a rotor 118 is fixed.

The inverter unit 140 is provided on the suction housing 112 at its external surface opposite to the discharge housing 111. The inverter unit 140 includes an aluminum base 142, a circuit board 146, and an inverter cover 144.

The inverter cover 144 covers the circuit board 146 to protect it from contamination, humidity, and the like. The inverter cover 144 is preferably formed of a resin for weight reduction. More preferably, the inverter cover 144 is formed by disposing a metal plate in the resin so as to suppress emission of generated electromagnetic noise from the circuit board 146 to outside. The inverter cover 144 is fixed to the suction housing 112 by screws 152, 154 at both sides with legs 156, 158 interposed therebetween. The legs 156, 158 are formed in the bottom plate 161 of the aluminum base 142. In the inverter cover 144, a power supply input port 143 having a cylindrical shape is formed to be supplied with a DC power supply voltage from outside.

The circuit board 146 is accommodated in an accommodation space between the inverter cover 144 and the aluminum base 142 such that the mounting surface of the circuit board 146 is orthogonal to the axial direction of the rotating shaft 119. In the present embodiment, the compressing unit 115, the electric motor 116, and the inverter unit 140 are arranged side by side in this order in the axial direction of the rotating shaft 119.

The aluminum base 142 is fastened to the suction housing 112 using the screws 152, 154. The aluminum base 142 and the suction housing 112 are each made of metal having good heat conductivity and are in close contact with each other. Hence, the aluminum base 142 serves to dissipate heat from the inverter unit 140 by conducting the heat in the inverter unit 140 to the suction housing 112.

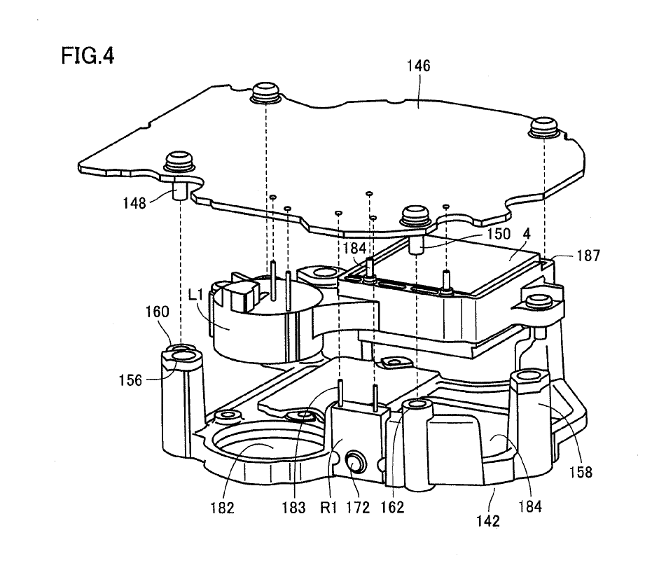

The circuit board 146 is fixed by the screws 148, 150 to the legs 160, 162 formed in the bottom plate 161 of the aluminum base 142, with a space between the circuit board 146 and the bottom plate 161. In the space therebetween, a driving control circuit (inverter circuit) for the electric motor 116 as well as an electromagnetic coil L1 and a capacitor circuit 4, which form a below-described filter circuit shown in FIG. 4, are accommodated. The driving control circuit, the electromagnetic coil L1 and the capacitor circuit 4 are mounted on the circuit board 146.

The electric power controlled by the inverter unit 140 is supplied to the electric motor 116, thereby rotating the rotor 118 and the rotating shaft 119 at a controlled rotational speed. By this rotation, the compressing unit 115 is driven. By driving the compressing unit 115, the refrigerant is suctioned from the external refrigerant circuit into the suction housing 112 via the suction port, the refrigerant thus suctioned into the suction housing 112 is compressed by the compressing unit 115, and the compressed refrigerant is discharged to the external refrigerant circuit via the discharge port 114.

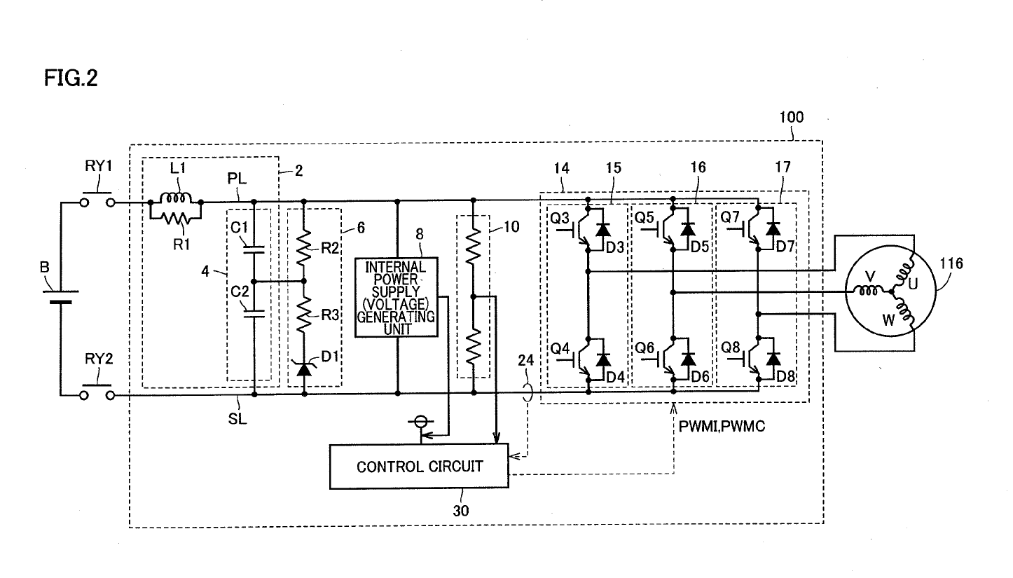

FIG. 2 is a circuit diagram of the driving circuit that drives the electric compressor motor. Referring to FIG. 2, the driving circuit 100 includes: the electromagnetic coil L1 and the capacitor circuit 4; an inverter circuit 14; a bleeder resistance circuit 6; an internal power supply voltage generating unit 8; a resistance circuit 10; and a control circuit 30.

The inverter circuit 14 includes a U phase arm 15, a V phase arm 16, and a W phase arm 17, each of which is connected between a positive electrode bus PL and a negative electrode bus SL.

The U phase arm 15 includes: transistors Q3, Q4 connected in series between the positive electrode bus PL and the negative electrode bus SL; and diodes D3, D4 respectively connected in anti-parallel with the transistors Q3, Q4. A connection node of the transistors Q3, Q4 is connected to one end of the U phase coil of the stator of the electric motor 116.

The V phase arm 16 includes: transistors Q5, Q6 connected in series between the positive electrode bus PL and the negative electrode bus SL; and diodes D5, D6 respectively connected in anti-parallel with the transistors Q5, Q6. A connection node of the transistors Q5, Q6 is connected to one end of the V phase coil of the stator of the electric motor 116.

The W phase arm 17 includes: transistors Q7, Q8 connected in series between the positive electrode bus PL and the negative electrode bus SL; and diodes D7, D8 respectively connected in anti-parallel with the transistors Q7, Q8. A connection node of the transistors Q7, Q8 is connected to one end of the W phase coil of the stator of the electric motor 116.

The other end of each of the U phase coil, the V phase coil, and the W phase coil of the stator of the electric motor 116 is connected to a neutral point.

Examples of the transistors Q3 to Q8 used herein include semiconductor transistors such as insulated gate bipolar transistors and electric field effect transistors.

By controlling switching of the transistors Q3 to Q8, a three-phase alternating current is output from the inverter circuit 14 to the stator coils of the electric motor 116.

The inverter circuit 14 is supplied with a DC voltage from a DC power supply B via relays RY1, RY2 and a low-pass filter circuit 2.

The electromagnetic coil L1, the capacitor circuit 4, and the damping resistor R1 are included in the low-pass filter circuit 2. The low-pass filter circuit 2 suppresses passage of high-frequency component of the voltage from the DC power supply B to the inverter circuit 14, and suppresses passage of high-frequency component of the voltage from the inverter circuit 14 to the DC power supply B side. The high-frequency component of the voltage refers to a voltage component having a frequency equal to or higher than a predetermined value. The predetermined value is a cutoff frequency determined from the electromagnetic coil L1, the capacitor circuit 4, and the damping resistor R1.

The electromagnetic coil L1 is connected between the positive electrode of the DC power supply B and the positive electrode bus PL. The damping resistor R1 is connected between the positive electrode of the DC power supply B and the positive electrode bus PL and is connected in parallel with the electromagnetic coil L1. The capacitor circuit 4 is connected between the positive electrode bus PL and the negative electrode bus SL.

The capacitor circuit 4 includes capacitors C1 and C2 connected in series between the positive electrode bus PL and the negative electrode bus SL.

The bleeder resistance circuit 6 is provided to suppress variation in a ratio between voltages held by the capacitors C1, C2. The bleeder resistance circuit 6 includes resistors R2, R3 and a Zener diode D1 connected in series between the positive electrode bus PL and the negative electrode bus SL. A connection node of the resistors R2, R3 is connected to the connection node of the capacitors C1, C2.

The internal power supply voltage generating unit 8 generates an internal power supply voltage used in the control circuit 30. The resistance circuit 10 divides the voltage using resistance elements connected in series between the positive electrode bus PL and the negative electrode bus SL so as to decrease it to a voltage that can be monitored by the control circuit 30, and outputs the divided voltage to the control circuit 30.

A current sensor 24 detects a current flowing in the negative electrode bus SL. The current flowing in the negative electrode bus SL is obtained by superimposing a W phase current, a V phase current, and a U phase current. The W phase current is a current flowing in the W phase coil. The V phase current is a current flowing in the V phase coil. The U phase current is a current flowing in the U phase coil.

The control circuit 30 is configured to include a CPU (Central Processing Unit) and the like and executes a computer program that controls driving of the electric motor 116.

It should be noted that the DC power supply B in the present embodiment may supply electric power to a three-phase drive motor in addition to the electric motor 116. The three-phase drive motor performs a power running operation for driving driving wheels of a hybrid vehicle or an electric vehicle, and a regenerative operation for generating electric power using rotational force of the driving wheels.

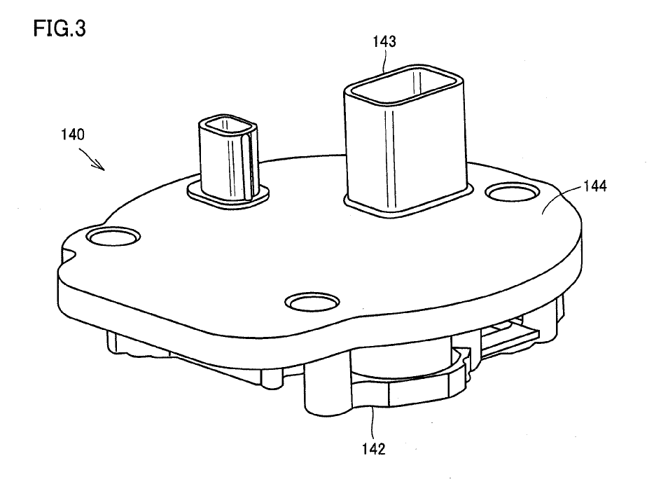

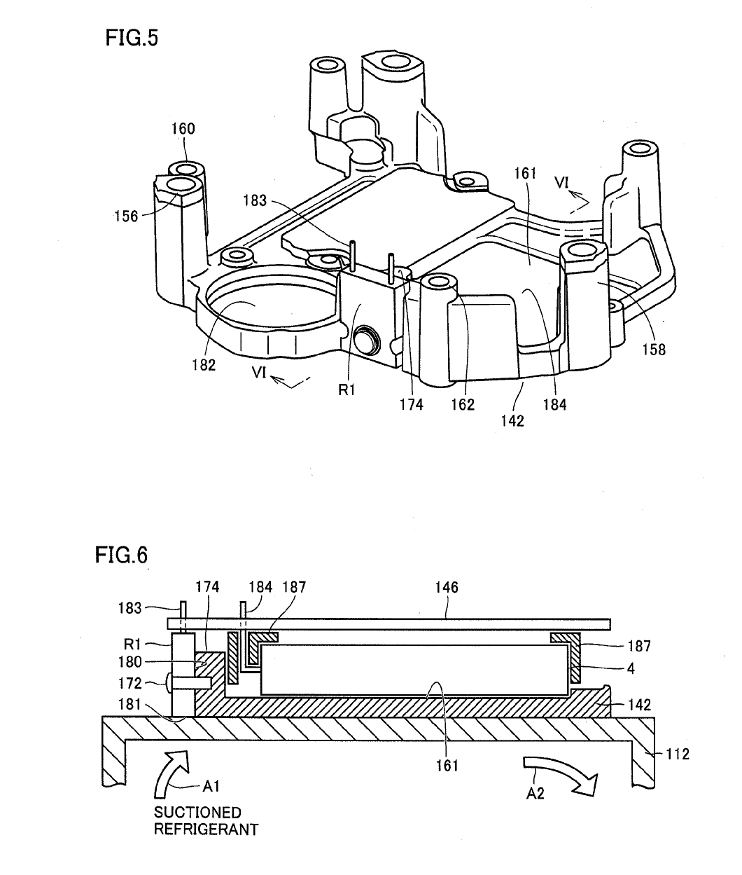

FIG. 3 is a perspective view showing an external appearance of the inverter unit. FIG. 4 shows a lamination structure within the inverter unit. FIG. 5 is a perspective view showing a shape of the aluminum base. Referring to FIG. 3 to FIG. 5, the inverter cover 144 covers the circuit board 146, which is fixed above the aluminum base 142, to protect the circuit board 146. Onto the circuit board 146, each of leads of the electromagnetic coil L1, the capacitor circuit 4, and the damping resistor R1 included in the filter circuit 2 is soldered, thereby mounting the electromagnetic coil L1, the capacitor circuit 4, and the damping resistor R1 thereon.

The aluminum base 142 includes the bottom plate 161 and the legs 156, 158, 160, 162 provided in the bottom plate 161. The circuit board 146 is attached to the legs 160, 162 by the screws 148, 150. The inverter cover 144 is attached to the legs 156, 158 by screws not shown in the figure.

In the bottom plate 161 of the aluminum base 142, the depressions 182, 184 are formed in conformity with the shapes of the electromagnetic coil L1 and the capacitor circuit 4. By providing the depressions in the aluminum base 142 in this way, the electromagnetic coil L1 and the capacitor circuit 4 can be brought into close contact with the aluminum base 142. Accordingly, heat generated in the filter circuit 2 can be dissipated from the aluminum base to the housing.

Further, in the present embodiment, it is designed such that the damping resistor R1 can be also readily in the close contact with the aluminum base.

In the present embodiment, the damping resistor R1 is not surface-mounted on the circuit board 146. Rather, the damping resistor R1 employed herein is a package attached thereto by soldering at a lead 183 with the damping resistor R1 standing from the circuit board 146. Also, the damping resistor R1 is attached to the side surface portion of the aluminum base 142 in close contact with each other by a screw 172.

FIG. 6 is a cross sectional view of a VI-VI portion in FIG. 5. Referring to FIG. 5 and FIG. 6, the aluminum base 142 includes: the bottom plate 161; and a wall portion 174 formed to stand from the bottom plate 161 toward the circuit board 146 and in abutment with the damping resistor R1.

To the circuit board 146, the damping resistor R1 and the capacitor 4 are respectively soldered at portions of the leads 183, 184. Further, the capacitor 4 is positioned by a resin holder 187 disposed at the circuit board 146. The resin holder 187 has an opening opposite to the circuit board 146, and the capacitor 4 and the aluminum base 142 are in abutment with each other such that heat conduction is good therebetween.

The aluminum base 142 is provided with a recess at a portion provided with the wall portion 174. In the recess, the damping resistor R1 is disposed. The side portion 180 of the damping resistor R1 abuts the aluminum base 142.

The bottom plate 161 of the aluminum base 142 is attached to the suction housing 112 such that heat conduction is good therebetween. The aluminum base 142 is attached at a position away from the compressing unit 115 in FIG. 1 and close to the suction port via which the refrigerant is suctioned.

Referring to FIG. 1 again, in the electric compressor 110, the refrigerant is suctioned via the suction port. The temperature of the suctioned refrigerant is low, so that the suction housing 112 of the electric compressor 110 is cooled by the suctioned refrigerant. The suctioned refrigerant passes through the motor 116, and is compressed by the compressing unit 115 to become a discharged gas having a high temperature and a high pressure, which is then discharged from the discharge port 114 to the external refrigerant circuit.

As shown in FIG. 6, the suctioned refrigerant is circulated at the inner surface of the suction housing 112. To the external surface of the suction housing 112, the aluminum base 142, the damping resistor R1, and the capacitor 4 are fixed. The position at which the aluminum base 142 is attached in the suction housing 112 is cooled by the suctioned refrigerant flowing as indicated by arrows A1, A2. Accordingly, the aluminum base 142 in contact with this portion is also cooled by the suctioned refrigerant, whereby the damping resistor R1 and the capacitor 4 are also cooled by the suctioned refrigerant.

Further, the wall portion 174 is provided to stand and the wall portion 174 and the side portion 180 of the damping resistor R1 are in abutment with each other, thereby providing a wide area at which the aluminum base 142 is in close contact with the damping resistor R1. This leads to good heat dissipation.

Further, in FIG. 6, the bottom portion 181 of the damping resistor R1 is directly in abutment with the suction housing 112. Therefore, the heat of the damping resistor R1 is also dissipated from the bottom portion 181 to the suction housing 112, whereby the damping resistor R1 is cooled more.

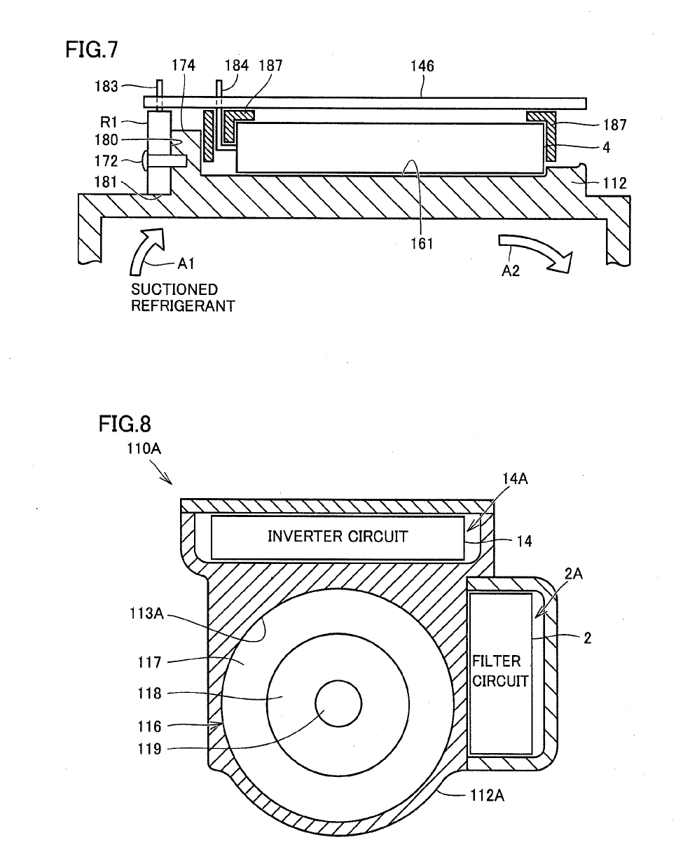

FIG. 7 illustrates a first modification. Each of FIG. 1 and FIG. 6 has illustrated the embodiment in which the aluminum base 142 is attached to the suction housing 112 and the damping resistor R1 is in abutment with the aluminum base 142. FIG. 7 illustrates an embodiment in which a portion of the suction housing 112 is changed into a shape corresponding to the aluminum base 142.

FIG. 8 illustrates a second modification. FIG. 1 has illustrated the example in which the inverter circuit and the filter circuit are accommodated in the same inverter unit 140. In contrast, FIG. 8 illustrates an embodiment in which the inverter circuit 14 and the filter circuit 2 are disposed at different positions in the suction housing 112A.

Referring to FIG. 8, an electric compressor 110A includes: an inverter circuit accommodating portion 14A in which the inverter circuit 14 is accommodated; and a filter circuit accommodating portion 2A in which the filter circuit 2 is accommodated. The inverter circuit accommodating portion 14A and the filter circuit accommodating portion 2A are provided at different positions in the suction housing 112A.

In the inner surface 113A of the suction housing 112A, the motor 116 is accommodated and the suctioned refrigerant is distributed. The motor 116 includes the stator 117, the rotor 118, and the rotating shaft 119.

There is no limitation as long as they are disposed at different positions, but as shown in FIG. 8, for example, the inverter circuit accommodating portion 14A can be disposed at the external surface of the suction housing 112A above the motor accommodating portion and the filter circuit accommodating portion 2A can be disposed at the external surface of the suction housing 112A lateral to the motor accommodating portion.

Finally, referring to the figures again, the present embodiment is summarized as follows. Referring to FIG. 1, an electric compressor 110 of the present embodiment includes: a compressing unit 115; an electric motor 116 that rotates the compressing unit 115; and a driving circuit 100 that drives the electric motor 116. Referring to FIG. 1 and FIG. 2, the driving circuit 100 includes a filter circuit 2 inserted in a power supply line PL, an inverter circuit 14 that receives electric power from the power supply line PL via the filter circuit 2, and a circuit board 146 on which the inverter circuit 14 is disposed. The filter circuit 2 has an electromagnetic coil L1, and a damping resistor R1. The damping resistor R1 is cooled by suctioned refrigerant for the electric compressor.

Preferably, the electric compressor 110 further includes a housing (the suction housing 112) that is made of metal and that accommodates the compressing unit 115 and the electric motor 116. The damping resistor R1 is fixed to an external surface of the housing 112.

More preferably, the electric compressor 110 further includes a base member (the aluminum base 142) that is attached to the external surface of the housing 112, that supports the circuit board 146, and that is made of metal. The damping resistor R1 is fixed to the aluminum base 142.

Further preferably, as shown in FIG. 5 and FIG. 6, the aluminum base 142 includes a leg 160, 162 onto which the circuit board 146 is attached, a bottom plate 161 in which the leg 160, 162 is formed, and a wall portion 174 formed to stand from the bottom plate 161 toward the circuit board 146 and in abutment with the damping resistor R1. The damping resistor R1 abuts wall portion 174.

Further preferably, as shown in FIG. 5 and FIG. 6, in the aluminum base 142, a recess is formed at a portion provided with the wall portion 174, and the damping resistor R1 is disposed in the recess and a side portion 180 of the damping resistor R1 abuts the aluminum base 142.

Further preferably, the damping resistor R1 has a bottom portion 181 in abutment with the housing 112.

Further preferably, as shown in FIG. 8, the electric compressor 110A further includes: an inverter circuit accommodating portion 14A in which the inverter circuit 14 is accommodated; and a filter circuit accommodating portion 2A in which the filter circuit 2 is accommodated. The inverter circuit accommodating portion 14A and the filter circuit accommodating portion 2A are formed at different positions in the housing 112A.

It should be noted that as shown in FIG. 7, by incorporating the aluminum base 142 into a portion of the suction housing 112, the aluminum base 142 may be configured as a portion of the metal housing in which the compressing unit 115 and the electric motor 116 are accommodated. In this case, the circuit board 146 is attached to the external surface of the suction housing 112.

In the present embodiment, the damping resistor R1 is provided on the housing or the aluminum base so as to provide a structure capable of cooling the damping resistor R1 also when stopping the operation of the compressor.

With such a structure, heat generated in the damping resistor is dissipated to the housing of the compressor, thereby reducing the temperature increase of the damping resistor.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An electric compressor comprising:
a compressing unit;
an electric motor that rotates the compressing unit; and
a driving circuit that drives the electric motor,
the driving circuit including
a filter circuit inserted in a power supply line,
an inverter circuit that receives electric power from the power supply line via the filter circuit, and
a circuit board on which the inverter circuit is disposed,
the filter circuit including
a coil, and
a damping resistor, the damping resistor being cooled by suctioned refrigerant suctioned in the electric compressor.

2. The electric compressor according to claim 1, further comprising a housing that is made of metal and that accommodates the compressing unit and the electric motor, wherein the damping resistor is fixed to an external surface of the housing.

3. The electric compressor according to claim 2, further comprising a base member that is attached to the external surface of the housing, that supports the circuit board, and that is made of metal, wherein the damping resistor is fixed to the base member.

4. The electric compressor according to claim 3, wherein
the base member includes
a leg onto which the circuit board is attached,
a bottom plate in which the leg is formed, and
a wall portion formed to stand from the bottom plate toward the circuit board, and
the damping resistor abuts the wall portion.

5. The electric compressor according to claim 4, wherein
in the base member, a recess is formed at a portion provided with the wall portion, and
the damping resistor is disposed in the recess and a side portion of the damping resistor abuts the base member.

6. The electric compressor according to claim 5, wherein the damping resistor has a bottom portion in abutment with the housing.

7. The electric compressor according to claim 2, further comprising: an inverter circuit accommodating portion in which the inverter circuit is accommodated; and a filter circuit accommodating portion in which the filter circuit is accommodated, wherein the inverter circuit accommodating portion and the filter circuit accommodating portion are formed at different positions in the housing.

8. The electric compressor according to claim 3, further comprising: an inverter circuit accommodating portion in which the inverter circuit is accommodated; and a filter circuit accommodating portion in which the filter circuit is accommodated, wherein the inverter circuit accommodating portion and the filter circuit accommodating portion are formed at different positions in the housing.

9. The electric compressor according to claim 4, further comprising: an inverter circuit accommodating portion in which the inverter circuit is accommodated; and a filter circuit accommodating portion in which the filter circuit is accommodated, wherein the inverter circuit accommodating portion and the filter circuit accommodating portion are formed at different positions in the housing.

10. The electric compressor according to claim 5, further comprising: an inverter circuit accommodating portion in which the inverter circuit is accommodated; and a filter circuit accommodating portion in which the filter circuit is accommodated, wherein the inverter circuit accommodating portion and the filter circuit accommodating portion are formed at different positions in the housing.

11. The electric compressor according to claim 6, further comprising: an inverter circuit accommodating portion in which the inverter circuit is accommodated; and a filter circuit accommodating portion in which the filter circuit is accommodated, wherein the inverter circuit accommodating portion and the filter circuit accommodating portion are formed at different positions in the housing.
